(19) United States
(12) Patent Application Publication
(10) Pub. No.: US 2026/0014851 A1
(43) Pub. Date: Jan. 15, 2026

(54) DRIVE ASSEMBLY, AXLE AND WORK MACHINE

(71) Applicant: Deere & Company, Moline, IL (US)

(72) Inventors: KRUTIN VINODKUMAR RAJANI, BACKNANG (DE); MANUEL MANN, Mannheim (DE)

(21) Appl. No.: 19/225,251

(22) Filed: Jun. 2, 2025

(30) Foreign Application Priority Data
Jul. 12, 2024 (EP) 24188295.0

(51) Int. Cl. B60K 17/28; B60K 1/02; B60K 17/02; B60L 50/60

(52) U.S. Cl. CPC B60K 17/28; B60K 1/02; B60K 17/02; B60L 50/60

(57) ABSTRACT

A drive assembly for a work machine include a first energy machine, a second energy machine, a travel drive, and a first power output, wherein the first energy machine is connected to the travel drive and the second energy machine is connected to the first power output when a rotational speed of the first energy machine is less than or equal to a rotational speed threshold value, and the second energy machine is connected to the travel drive when a rotational speed of the first energy machine is greater than the rotational speed threshold value.

### CROSS-REFERENCE TO RELATED APPLICATIONS

This application claims priority to European Patent Application No. 24188295.0, filed Jul. 12, 2024, which is hereby incorporated by reference.

### FIELD OF THE DISCLOSURE

The disclosure relates to a drive assembly for a work machine.

### BACKGROUND

Work machines, for example construction machines or agricultural work vehicles, for example agricultural towing vehicles or farm tractors, are usually driven by internal combustion engines. In this context, the internal combustion engine can drive one or more axles of the work machine, in particular a rear axle and/or a front axle. The axle(s) is (are) usually driven by the crankshaft of the internal combustion engine via a transmission with a variable transmission ratio and one or more travel drives, in particular one or more differentials. The travel drive, in particular the differential, can be in drive connection on the driven side with the shafts of the wheels, in particular the front and/or rear wheels.

The internal combustion engine can likewise additionally drive a first power output, in particular a mechanical power output. More specifically, the internal combustion engine can drive a PTO unit, in particular a power takeoff shaft. The PTO unit can be situated on a rear side of the work machine, in particular in the vicinity of an attachment interface for implements.

### SUMMARY

According to an aspect of the present disclosure, a drive assembly for a work machine includes a first energy machine, a second energy machine, a travel drive, and a first power output, wherein the first energy machine is connected to the travel drive and the second energy machine is connected to the first power output when a rotational speed of the first energy machine is less than or equal to a rotational speed threshold value, and the second energy machine is connected to the travel drive when a rotational speed of the first energy machine is greater than the rotational speed threshold value.

According to an aspect of the present disclosure, the second energy machine is connected to the travel drive and the first power output when the rotational speed of the first energy machine is greater than the rotational speed threshold value.

According to an aspect of the present disclosure, the drive assembly comprises a first coupling device, wherein the first energy machine is connected to the first coupling device and is connectable to the travel drive via the first coupling device, and the drive assembly comprises a second coupling device, wherein the second energy machine is connected to the second coupling device and is connectable to the first power output via the second coupling device.

According to an aspect of the present disclosure, the drive assembly includes a third coupling device, and the second energy machine is connected to the third coupling device and is connectable to the travel drive via the third coupling device.

According to an aspect of the present disclosure, the drive assembly includes a fourth coupling device, and the first energy machine is connected to the fourth coupling device, and the first energy machine is connectable to the first power output via the fourth coupling device.

According to an aspect of the present disclosure, the drive assembly includes a second power output.

According to an aspect of the present disclosure, the first energy machine is connected to the travel drive, and the second energy machine is connected to at least one of the first or second power output, when a rotational speed of the first energy machine is less than or equal to the rotational speed threshold value, and the second energy machine is connected to the travel drive when a rotational speed of the first energy machine is greater than the rotational speed threshold value.

According to an aspect of the present disclosure, the drive assembly includes a third energy machine connected to the second power output.

According to an aspect of the present disclosure, the first power output includes a first angular gear set, and the second power output includes a second angular gear set.

According to an aspect of the present disclosure, the first, second, and third energy machines and the travel drive are arranged coaxially with or parallel to one another.

According to an aspect of the present disclosure, an axle for a work machine includes the drive assembly disclosed herein.

According to an aspect of the present disclosure, a work machine includes an axle having the drive assembly disclosed herein.

The above and other features will become apparent from the following detailed description and accompanying drawings.

### BRIEF DESCRIPTION OF THE DRAWINGS

The disclosure and other advantages and advantageous developments and modifications of the disclosure will be explained in greater detail below both in terms of hardware and in terms of method, using example embodiments and with reference to the drawings. Component parts of equivalent or comparable function are identified by the same reference signs in this case. In the drawings:

FIG. 1 shows a schematic illustration of a first example embodiment of a work machine according to the disclosure, in particular an agricultural towing vehicle in the form of a farm tractor;

FIG. 2 shows a schematic illustration of the first example embodiment of the drive assembly according to the disclosure;

FIG. 3 shows a schematic illustration of a second example embodiment of the drive assembly according to the disclosure;

FIG. 4 shows a schematic illustration of a third example embodiment of the drive assembly according to the disclosure;

FIG. 5 shows a schematic illustration of a fourth example embodiment of the drive assembly according to the disclosure;

FIG. 6 shows a schematic illustration of a fifth example embodiment of the drive assembly according to the disclosure; and

FIG. 7 shows a schematic illustration of a sixth example embodiment of the drive assembly according to the disclosure.

### DETAILED DESCRIPTION

The embodiments or implementations disclosed in the above drawings and the following detailed description are not intended to be exhaustive or to limit the present disclosure to these embodiments or implementations.

There are currently proposals for driving work machines of this kind by means of electric motors, in particular as purely battery-operated vehicles. One approach would transfer the existing drivetrain (constructed using a shaft running in the longitudinal direction but now driven by electric motor, and a differential) to such vehicles, as shown in US 2023/0227106 A1. DE 10 2008 032 848 A1 shows an axle for a work vehicle, in particular a floor conveyor, having a differential which is in drive connection on the driven side with the shafts of the rear wheels. The differential is driven by an electric motor via a hollow shaft, which coaxially surrounds one of the shafts of the rear wheels. For its part, the hollow shaft is driven via an electric motor designed as an internal-rotor motor, which is fitted around the hollow shaft. DE 10 2020 114 063 A1 shows a similar arrangement for a final drive of a motor vehicle but with a gear mechanism between the electric motor and the hollow shaft and a shift transmission between the hollow shaft and the differential.

In some approaches, the power takeoff shaft is driven by the internal combustion engine, wherein a superposition gear mechanism coupled to an additional electric motor can be used for setting the rotational speed (DE 10 2017 205 149 A1, EP 1 466 773 A2). In the case of purely electric drives, it has been proposed to drive the power takeoff shaft by means of a first electric motor, which is connected by a superposition gear mechanism to the travel drive, while the superposition gear mechanism is also driven by a further electric motor (DE 10 2019 106 294 A1).

The disadvantage of the known drive assemblies is that they do not allow power shifting, in particular they cannot be shifted seamlessly, and/or they do not have a sufficient number of gear ratios for the travel drive and/or the first power output. Moreover it is disadvantageous that the known drive assemblies are too complicated or complex in terms of design configuration.

Based on these approaches, it is therefore an object of the present disclosure to propose a drive assembly, an axle and a work machine which largely avoid the disadvantages known from these approaches. The present disclosure is therefore based, in particular, on the object of proposing a drive assembly, an axle and a work machine by means of which the aforementioned problems are overcome. More specifically, it is an object of the present disclosure to propose a drive assembly, an axle and a work machine which are of structurally simple configuration and/or have a plurality of gear ratios and/or are of lower-cost configuration and/or can for example be shifted seamlessly and in a synchronized manner.

This object is achieved by a drive assembly having the features of one or more embodiments disclosed herein, and an axle having the features of one or more embodiments disclosed herein, and a work machine having the features of one or more embodiments disclosed herein. The dependent claims relate to additional advantageous embodiments of the disclosure.

According to the disclosure, a drive assembly for a work machine is proposed. More specifically, the proposal is, in particular, for a drive assembly for an axle of a work machine, for example an electrically driven axle of a work machine. The drive assembly comprises a first and a second energy machine. The drive assembly furthermore comprises a travel drive and a first power output. The first energy machine, in particular only the first energy machine, is connected to the travel drive, and the second energy machine, in particular only the second energy machine, is connected to the first power output, when a rotational speed of the first energy machine is less than or equal to the rotational speed threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. Alternatively or in addition, the second energy machine, in particular only the second energy machine, is connected to the travel drive when a torque of the first energy machine is greater than the torque threshold value and/or a rotational speed of the first energy machine is greater than the rotational speed threshold value.

The first and/or second energy machine can be designed as electric motors, in particular as a first and second electric motor. Alternatively or in addition, the first and/or second energy machine can be designed as a fuel cell, in particular as a first and second fuel cell. However, the first and/or second energy machine can also be a permanent-magnet and/or electrically excited synchronous and/or asynchronous machine that is operated using direct current and/or three-phase current, for example a permanent-magnet three-phase synchronous machine. The first and second energy machine can be operable as motors or generators. The first and second energy machines can drive the drive assembly, in particular the travel drive and/or the first power output, with a rotational speed and/or a force and/or a torque. The first energy machine, in particular the first electric motor, can comprise a first drive shaft. The second energy machine, in particular the second electric motor, can comprise a second drive shaft.

The drive assembly, in particular the axle or the work machine, can comprise one or more energy stores. The energy store or stores can be connected and/or couplable, in particular electrically connected and/or electrically couplable, to the first and/or second energy machine. The energy store can be an electric energy store. The energy store can supply the connected energy machine(s) with energy, in particular electrical energy. The energy store can be designed as a battery and/or a rechargeable battery and/or a supercapacitor and/or a fuel cell and/or some other device for storing electrical energy.

Connected can for example be understood as meaning mechanically connected, for example drivably connected, i.e. connected in a torque- and/or speed-transmitting manner, and/or coupled or couplable, i.e. mechanically coupled and/or rigidly coupled or mechanically couplable. Mechanically connected, for example drivably connected and/or coupled or couplable, or mechanically coupled and/or rigidly coupled or mechanically couplable, can therefore be understood as meaning in particular a connection of two components which makes it possible to transmit an energy and/or a force and/or a torque and/or a rotational speed from one component to the other, in particular mechanically. Further components or parts enabling such a transmission of energy and/or force and/or torque and/or transmission of a rotational speed between the two components can be provided between the two components.

The travel drive can comprise a first output shaft and/or can be designed as a first output shaft. The travel drive can likewise comprise a differential and the first output shaft. In this instance, the differential can be connected on the drive side to the first output shaft. In addition, the differential can be connected on the driven side to a left-hand shaft and to a right-hand shaft in order to drive ground-engaging means on the axle. The first output shaft can be designed as a hollow shaft, which, in particular, partially or completely surrounds the left-hand and/or right-hand shaft.

The first power output can comprise a second output shaft and/or can be designed as a second output shaft. The first power output can likewise additionally comprise a PTO unit. The PTO unit can comprise a PTO gear and/or a power takeoff shaft. The PTO unit, in particular the PTO gear, can be connected on the drive side to the second output shaft. In addition, the PTO unit, in particular the PTO gear, can be connectable or connected on the driven side to the power takeoff shaft.

By virtue of the allocation such that the torque of the first energy machine can be less than the torque threshold value or greater than or equal to the torque threshold value and/or the rotational speed of the first energy machine can be less than or greater than or equal to the rotational speed threshold value, two modes of the drive assembly and/or of the work machine are defined. In other words, two speed ranges of the drive assembly and/or of the work machine are defined.

The first mode or first speed range pertains when the torque of the first energy machine is less than or equal to the torque threshold value and/or the rotational speed of the first energy machine is less than or equal to the rotational speed threshold value, that is to say when the following applies:

n≤n_{schwell} and/or T≤T_{schwell}

or when the torque of the first energy machine is less than the torque threshold value and/or the rotational speed of the first energy machine is less than the rotational speed threshold value, that is to say when the following applies:

$$n < {n}_{schwell} and / or T < {T}_{schwell}$$

where
n=rotational speed of the first energy machine
N_{schwell}=rotational speed threshold value, in particular the maximum rotational speed of the first energy machine
T=torque of the first energy machine
T_{schwell}=torque threshold value, in particular the maximum torque of the first energy machine

A shift point may be present when n=n_{schwell} and/or T=T_{schwell} applies. Thus, if the rotational speed n of the first energy machine corresponds to the rotational speed threshold value n_{schwell}, i.e. if, in particular, n=n_{schwell} applies and/or if the torque T corresponds to the torque threshold value T_{schwell}, i.e. if therefore T=T_{schwell} applies, a gear change, in particular a synchronized gear change to the second mode or the second speed range, takes place. The gear change can take place under full load and without an interruption in the tractive effort and, in particular, can take place seamlessly. The first and second energy machine can have the same rotational speed at the shift point, that is to say, in particular, if n=n_{schwell} and/or T=T_{schwell} applies. By virtue of the seamless shifting, vibration and/or shaking (“shift shock”) of the drive assembly can be avoided.

The second mode or second speed range pertains when the torque of the first energy machine is greater than the torque threshold value and/or the rotational speed of the first energy machine is greater than the rotational speed threshold value, that is to say when the following applies:

$$n > {n}_{schwell} and / or T > {T}_{schwell}$$

In the first mode or the first speed range, the following applies, it being possible, in particular, for the drive assembly to be operable as follows in the first mode or the first speed range:
The first energy machine, in particular only the first energy machine, is connected, in particular coupled, to the travel drive, and the travel drive can be driven by means of the first energy machine. The first energy machine can thus provide torque and/or rotational speed, that is to say, in particular, also traction, for the travel drive as the only machine. It is thereby possible to use the drive assembly and, in particular, at low speeds (n≤n_{schwell} or n<n_{schwell} and/or T≤T_{schwell} or T<T_{schwell}), the working machine, with a constant individual transmission ratio. Moreover, a high traction torque and a high tractive effort of the work machine can be enabled at low speeds.
The second energy machine, in particular only the second energy machine, is connected, in particular coupled, to the first power output, and the first power output can be driven by means of the second energy machine. As a result, this machine can supply torque and/or rotational speed for the first power output as the only machine.

In the second mode or the first speed range, the following applies, it being possible, in particular, for the drive assembly to be operable as follows in the second mode or the second speed range:
The second energy machine, in particular only the second energy machine, is connected, in particular coupled, to the travel drive, and the travel drive can be driven by means of the second energy machine. The first energy machine can be decoupled from the travel drive.
From this rotational speed and/or this torque, the first energy machine no longer supplies any torque and/or rotational speed, that is to say, in particular, no traction, for the travel drive, and only the second energy machine supplies the torque and/or the rotational speed, that is to say, in particular, the full traction, for the travel drive.
In addition, it is possible for the first energy machine, in particular only the first energy machine, to be connected, in particular coupled, to the first power output, and for the first power output to be drivable by means of the first energy machine. As a result, this machine can supply torque and/or rotational speed for the first power output as the only machine. Depending on the transmission ratios selected, it is thereby also possible to achieve synchronized shifting of the first power output.

In other words, the drive assembly or the work machine or the axle can comprise a control unit. The control unit can be connected to the first and second energy machine for signaling, and/or operatively coupled thereto and/or connected thereto for transmitting signals and/or carrying data. The control unit can be configured to receive one or more rotational speed signals and/or torque signals from the drive assembly, in particular from rotational speed and/or torque sensors of the drive assembly, and/or from the first and/or second energy machine. The control unit can be configured to ascertain a rotational speed and/or a torque by means of the rotational speed signal and/or the torque signal. The control unit can be configured to compare the ascertained rotational speed and/or the ascertained torque to the rotational speed threshold value n_{schwell} and/or the torque threshold value T_{schwell}. The control unit can be configured to set and/or adjust, in particular also to operate, the rotational speed and/or the torque of the drive assembly, in particular of the first and second energy machine. The control unit can be configured to set and/or adjust the drive assembly, in particular the first and second energy machine, in accordance with the rotational speed and/or the torque in the first or second mode, in particular to operate them in the first or second mode. The control unit can be configured to set and/or adjust the drive assembly, in particular the first and second energy machine, to the first mode, in particular to operate it (them) in the first mode, in accordance with the rotational speed and/or the torque when the torque of the first energy machine is less than or equal to the torque threshold value and/or the rotational speed of the first energy machine is less than or equal to the rotational speed threshold value, when the torque of the first energy machine is less than the torque threshold value and/or the rotational speed of the first energy machine is less than the rotational speed threshold value. Alternatively or in addition, the control unit can be configured to set and/or adjust the drive assembly, in particular the first and second energy machine, to the second mode, in particular to operate it (them) in the second mode, in accordance with the rotational speed and/or the torque when the torque of the first energy machine is greater than or equal to the torque threshold value and/or the rotational speed of the first energy machine is greater than or equal to the rotational speed threshold value. The control unit can be configured to set and/or adjust and/or control, that is to say for example also to exercise open-loop and closed-loop control over, the drive assembly and thus also the axle or the work machine, for example to set and/or adjust the mode, in accordance with the rotational speed and/or the torque of the first energy machine and/or the torque threshold value and/or the rotational speed threshold value.

In some embodiments of the disclosure, the drive assembly thus comprises a travel drive and a first power output, for example a first mechanical power output and a mechanical travel drive, for example an electrically driven first mechanical power output and an electrically driven first mechanical travel drive. The first and second energy machine can alternately drive both the travel drive and the first power output in accordance with the rotational speed and/or the torque, in particular of the first energy machine. It is thereby possible to provide a plurality of gears with the respectively desired rotational speed and/or torque for the drive assembly. Moreover, synchronized shifting of gears, as in a two-stage transmission, is made possible without a second gear for one of the energy machines actually being required.

Seamless shifting of gears can also be implemented.

It is possible to dispense with a transmission that has a variable transmission ratio. In this way, a compact construction of the drive assembly is furthermore obtained. By virtue of the seamless shifting, vibration and/or shaking (“shift shock”) of the drive assembly can be avoided.

As a modification of the disclosure, the second energy machine is connected to the travel drive and the first power output when the torque of the first energy machine is greater than the torque threshold value and/or the rotational speed of the first energy machine is greater than the rotational speed threshold value. The second energy machine can thus additionally be connected to the travel drive and the first power output and can drive both. As a result, it is also possible to operate the first power output in the second mode. In this instance, the rotational speed of the first power output can be dependent on, in particular identical with, the rotational speed at the travel drive. The drive assembly has the advantages set out above.

As a modification of the disclosure, the drive assembly comprises a first and second coupling device. The first energy machine is connected to the first coupling device. In addition, the first energy machine is connectable or connected, in particular also releasably connected, to the first coupling device or is connectable or connected to the travel drive by means of the first coupling device. For this purpose, the first drive shaft can be connected to the first coupling device. Alternatively or in addition, the second energy machine is connected to the second coupling device. In addition, the second energy machine is connectable or connected, in particular also releasably connected, to the first power output by means of the second coupling device or via the second coupling device. For this purpose, the second drive shaft can be connected to the second coupling device. The first coupling device can be connectable or connected to the first output shaft. The second coupling device can be connectable or connected to the second output shaft.

The first and second coupling device can each be movable between a first position, in particular a closed or connected or coupled state, and a second position, in particular an open or unconnected or decoupled state. In the first position, the respective coupling devices can be connected to another component, e.g. the first or second output shaft. In the second position, it is possible for the respective coupling devices not to be connected to the other component, e.g. the first or second output shaft, i.e. to be released therefrom.

By means of the first or by the first coupling device, it is possible for the first energy machine to be connected to the travel drive, in particular the first output shaft, in the first position and not to be connected to the travel drive, in particular the first output shaft, i.e. to be decoupled, in the second position. By means of the second or by the second coupling device, it is possible for the second energy machine to be connected to the first power output, in particular the second output shaft, in the first position and not to be connected to the first power output, in particular the second output shaft, i.e. to be decoupled, in the second position.

The first and/or second coupling device can be designed as a clutch or synchronizer, e.g. as a shift clutch or a multiplate clutch or a synchromesh clutch or a switchable freewheel clutch.

The drive assembly can comprise a first transmission stage, in particular a first spur gear stage or a first gearwheel set or a first gearwheel pair or a first planetary set. The first energy machine can be connected to the first coupling device by the first or by means of the first transmission stage. The drive assembly can comprise a second transmission stage, in particular a second spur gear stage or a second gearwheel set or a second gearwheel pair or a second planetary set. The second energy machine can be connected to the second coupling device by the second or by means of the second transmission stage.

The first and second coupling device can be connected to the control unit for signaling, and/or operatively coupled thereto and/or connected thereto for transmitting signals and/or carrying data. In particular, the drive assembly can comprise a first valve or a first valve arrangement, in particular a first control valve, or a first actuator for controlling and/or setting and/or adjusting the first coupling device. The first valve or the first valve arrangement or the first actuator can be connected to the first coupling device. The drive assembly can likewise comprise a second valve or a second valve arrangement, in particular a second control valve, or a second actuator for controlling and/or setting and/or adjusting the second coupling device. The second valve or the second valve arrangement or the second actuator can be connected to the second coupling device.

The control unit can be connected to the first and/or second valve or the first and/or second valve arrangement or the first and/or second actuator for signaling and/or operatively coupled thereto and/or connected thereto for transmitting signals and/or carrying data. The control unit can be configured to control and/or set and/or adjust the first coupling device, in particular via the or by means of the first valve or the first valve arrangement or the first actuator. The control unit can be configured to set and/or adjust the first coupling device, in particular via the or by means of the first valve or the first valve arrangement or the first actuator, into the first or second position, in particular also to move it from the first into the second position and vice versa. The control unit can be configured to control and/or set and/or adjust the second coupling device, in particular via the or by means of the second valve or the second valve arrangement or the second actuator. The control unit can be configured to set and/or adjust the second coupling device, in particular via the or by means of the second valve or the second valve arrangement or the second actuator, into the first or second position, in particular also to move it from the first into the second position and vice versa. The drive assembly has the advantages set out above.

Further gears and coupling devices can be added to the drive assembly, thus making it possible to implement an n-gear-synchronized or seamless drive assembly. In the case of a seamless n-gear transmission with x shifts for the first power output when carrying out the various shifting operations, the number of coupling devices is specified as follows:
Number of coupling devices=n+x+1
where
n=number of gears of the travel drive
x=number of gears for the first power output

In a modification of the disclosure, the drive assembly comprises a third coupling device, and the second energy machine is connected to the third coupling device. In addition, the second energy machine is connectable or connected, in particular also releasably connected, to the travel drive by means of or by the third coupling device. The third coupling device can be connectable or connected to the first output shaft. In addition or as an alternative, the drive assembly can comprise a fourth coupling device, and the first energy machine is connected to the fourth coupling device. In addition, the first energy machine is connectable or connected, in particular also releasably connected, to the first power output by means of or by the fourth coupling device. The fourth coupling device can be connectable or connected to the second output shaft.

The third and fourth coupling device can each be movable between a first position, in particular a closed or connected or coupled state, and a second position, in particular an open or unconnected or decoupled state. In the first position, the respective coupling devices can be connected to another component, e.g. the first or second output shaft. In the second position, it is possible for the respective coupling devices not to be connected to the other component, e.g. the first or second output shaft, i.e. to be released therefrom.

By means of the fourth or by the fourth coupling device, it is possible for the first energy machine to be connected to the first power output, in particular the second output shaft, in the first position and not to be connected to the first power output, in particular the second output shaft, i.e. to be decoupled, in the second position. By means of the third or by the third coupling device, it is possible for the second energy machine to be connected to the travel drive, in particular the first output shaft, in the first position and not to be connected to the travel drive, in particular the first output shaft, i.e. to be decoupled, in the second position.

The third and/or fourth coupling device can be designed as a clutch or synchronizer, e.g. as a shift clutch or a multiplate clutch or a synchromesh clutch or a switchable freewheel clutch.

The drive assembly can comprise a third transmission stage, in particular a third spur gear stage or a third gearwheel set or a third gearwheel pair or a third planetary set. The second energy machine can be connected to the third coupling device by the third or by means of the third transmission stage. The drive assembly can comprise a fourth transmission stage, in particular a fourth spur gear stage or a fourth gearwheel set or a fourth gearwheel pair or a fourth planetary set. The first energy machine can be connected to the fourth coupling device by the fourth or by means of the fourth transmission stage.

The third and fourth coupling device can be connected to the control unit for signaling, and/or operatively coupled thereto and/or connected thereto for transmitting signals and/or carrying data. In particular, the drive assembly can comprise a third valve or a third valve arrangement, in particular a third control valve, or a third actuator for controlling and/or setting and/or adjusting the third coupling device. The third valve or the third valve arrangement or the third actuator can be connected to the third coupling device. The drive assembly can likewise comprise a fourth valve or a fourth valve arrangement, in particular a fourth control valve, or a fourth actuator for controlling and/or setting and/or adjusting the fourth coupling device.

The fourth valve or the fourth valve arrangement or the fourth actuator can be connected to the fourth coupling device.

The control unit can be connected to the third and/or fourth valve or the third and/or fourth valve arrangement or the third and/or fourth actuator for signaling and/or operatively coupled thereto and/or connected thereto for transmitting signals and/or carrying data. The control unit can be configured to control and/or set and/or adjust the third coupling device, in particular via the or by means of the third valve or the third valve arrangement or the third actuator. The control unit can be configured to set and/or adjust the third coupling device, in particular via the or by means of the third valve or the third valve arrangement or the third actuator, into the first or second position, in particular also to move it from the first into the second position and vice versa. The control unit can be configured to control and/or set and/or adjust the fourth coupling device, in particular via the or by means of the fourth valve or the fourth valve arrangement or the fourth actuator. The control unit can be configured to set and/or adjust the fourth coupling device, in particular via the or by means of the fourth valve or the fourth valve arrangement or the fourth actuator, into the first or second position, in particular also to move it from the first into the second position and vice versa.

The drive assembly has the advantages set out above. In addition, these measures enable the selection of various stages or gears or transmission ratios. As illustrated by way of example in Table 1, it is possible, depending on how the coupling units are shifted, that is to say whether they are in the first or second position, for only the travel drive, only the first power output, or the travel drive and the first power output, or the boosted travel drive and/or the boosted first power output to be used. The different rotational speeds of the travel drive and/or of the first power output or the speed of the work machine depend on the transmission ratios selected between the first and second energy machine. Moreover, the travel range can be restricted, depending on the transmission ratio. Moreover, the modes shown in Table 1 are based, for example, on a second energy machine with a higher power than the first energy machine. Depending on the configuration of the transmission stages and of the energy machines, a certain sequence must be maintained in the selection of the coupling devices in order to achieve synchronized shifting of the drive assembly.

TABLE 1
The various stages of the drive assembly with four coupling devices

| Stage | K1 | K2 | K3 | K4 | State | Mode |
|---|---|---|---|---|---|---|
| 1 | Closed | Open | Open | Open | Drive EM1 - travel drive | Only driving |
| 2 | Open | Open | Closed | Open | Drive EM2 - travel drive | Only driving |
| 3 | Closed | Open | Closed | Open | Drive EM1 and EM2 - travel drive | Power boosting, driving |
| 4 | Open | Closed | Open | Open | Drive EM2 - first power output | Only power output |
| 5 | Open | Open | Open | Closed | Drive EM1 - first power output | Only power output |
| 6 | Open | Closed | Open | Closed | Drive EM1 and EM2 - first | Power boosting, first |
| | | | | | power output | power output |
| 7 | Closed | Closed | Open | Open | Drive EM1 - travel drive and | Driving and power output |
| | | | | | EM2 - first power output | |
| 8 | Open | Open | Closed | Closed | Drive EM2 - travel drive and | Driving and power output |
| | | | | | EM1 - first power output | |
| 9 | Closed | Closed | Closed | Open | Drive EM1 and EM2 - travel drive | Power boosting, driving |
| | | | | | and EM2 - first power output | and power output |
| 10 | Closed | Closed | Open | Closed | Drive EM1 - travel drive and EM1 | Power boosting, driving |
| | | | | | and EM2 - first power output | and power output |
| 11 | Open | Closed | Closed | Closed | Drive EM2 - travel drive and | Power boosting, driving |
| | | | | | EM1 and EM2 - first power output | and power output |
| 12 | Open | Closed | Closed | Open | Drive EM2 - travel drive and | Power output, high |
| | | | | | first power output | rotational speed |
| 13 | Closed | Open | Open | Closed | Drive EM1 - travel drive and | Power output, low |
| | | | | | first power output | rotational speed |
| 14 | Open | Open | Open | Open | Neutral, no drive | Neutral |

In one possible embodiment, the drive assembly comprises a second power output, in particular a second mechanical power output. The second power output can drive the hydraulics, in particular the hydraulics of the work machine. The second power output can jointly comprise the second output shaft and the first power output. Alternatively, the second power output can comprise a third output shaft and/or be designed as a third output shaft. Likewise, the second power output can be a pump and/or compressor unit and/or a further PTO unit, which can be similar in design to the PTO unit. It is thereby possible to implement a total of two power outputs and the travel drive and/or to operate them independently of one another.

In a modification of the disclosure, the first energy machine, in particular only the first energy machine, is connected to the travel drive, and the second energy machine, in particular only the second energy machine, is connected to the first and/or second power output, when a rotational speed of the first energy machine is less than or equal to the rotational speed threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. The following can thus apply in the first mode or the first speed range, it being possible, in particular, for the drive assembly to be operable as follows in the first mode or the first speed range:
The first energy machine can be connected, in particular coupled, to the travel drive and can drive it.
The second energy machine can be connected, in particular coupled, to the first and/or second power output and can drive them (it).

In the second mode or the first speed range, i.e. when a torque of the first energy machine is greater than the torque threshold value and/or a rotational speed of the first energy machine is greater than the rotational speed threshold value, the following can apply, it being possible, in particular, for the drive assembly to be operable as follows in the second mode or the second speed range:
Alternatively or in addition, it is possible for the second energy machine, in particular only the second energy machine, to be connected to the travel drive. It is thus possible for the second energy machine to be coupled to the travel drive and to drive the latter.
Alternatively or in addition, it is possible for the first energy machine not to be connected to the travel drive, in particular to be decoupled from the travel drive.
Alternatively or in addition, it is possible for the first energy machine to be connected to the first and/or second power output. It is thus possible for the first energy machine, in particular, to be coupled to the first and/or second power output and to drive them (it).
Alternatively or in addition, it is possible for the second energy machine to be connected to the travel drive and the first and/or second power output. It is thus possible for the second energy machine, in particular, to be coupled to the travel drive and the first and/or second power output and to drive them.

The drive assembly can comprise a fifth coupling device. The second energy machine can be connected to the fifth coupling device. In addition, the second energy machine can be connectable or connected to the second power output by means of or by the fifth coupling device. The fifth coupling device can be connectable or connected to the second or third output shaft.

The fifth coupling device can in each case be movable between a first position, in particular a closed or connected or coupled state, and a second position, in particular an open or unconnected or decoupled state. In the first position, the fifth coupling devices can be connected to another component, e.g. the second or third output shaft. In the second position, it is possible for the fifth coupling devices not to be connected to the other component, i.e. to be released therefrom.

By means of the fifth or by the fifth coupling device, it is possible for the second energy machine to be connected to the second power output, in particular the second or third output shaft, in the first position, and not to be connected to the second or third power output, in particular the second or third output shaft, i.e. to be decoupled, in the second position.

The fifth coupling device can be designed as a clutch or synchronizer, e.g. as a shift clutch or a multiplate clutch or a synchromesh clutch or a switchable freewheel clutch.

The drive assembly can comprise a fifth transmission stage, in particular a fifth spur gear stage or a fifth gearwheel set or a fifth gearwheel pair or a fifth planetary set. The second energy machine can be connected to the fifth coupling device by the fifth or by means of the fifth transmission stage.

The fifth coupling device can be connected to the control unit for signaling, and/or operatively coupled thereto and/or connected thereto for transmitting signals and/or carrying data. In particular, the drive assembly can comprise a fifth valve or a fifth valve arrangement, in particular a fifth control valve, or a fifth actuator for controlling and/or setting and/or adjusting the fifth coupling device. The fifth valve or the fifth valve arrangement or the fifth actuator can be connected to the fifth coupling device.

The control unit can be connected to the fifth valve or the fifth valve arrangement or the fifth actuator for signaling and/or operatively coupled thereto and/or connected thereto for transmitting signals and/or carrying data. The control unit can be configured to control and/or set and/or adjust the fifth coupling device, in particular via the or by means of the fifth valve or the fifth valve arrangement or the fifth actuator. The control unit can be configured to set and/or adjust the fifth coupling device, in particular via the or by means of the fifth valve or the fifth valve arrangement or the fifth actuator, into the first or second position, in particular also to move it from the first into the second position and vice versa. The drive assembly has the advantages set out above.

In a modification of the disclosure, the drive assembly comprises a third energy machine. The third energy machine, in particular only the third energy machine, is connected to the second power output. The third energy machine can be connected to the second power output when a torque of the first energy machine is less than or equal to the torque threshold value and/or a rotational speed of the first energy machine is less than or equal to the rotational speed threshold value, for example when a torque of the first energy machine is less than the torque threshold value and/or a rotational speed of the first energy machine is less than the rotational speed threshold value. The energy store or stores can be connected and/or couplable, in particular electrically connected and/or electrically couplable, to the third energy machine.

The third energy machine can be designed as an electric motor, in particular as a third electric motor. However, the third energy machine can also be a fuel cell or, for example, permanent-magnet and/or electrically excited synchronous and/or asynchronous machine that is operated using direct current and/or three-phase current, for example a permanent-magnet three-phase synchronous machine. The third energy machine can be operable as a motor or a generator. The third energy machine can drive the drive assembly with a rotational speed and/or a torque. The third energy machine, in particular the third electric motor, can comprise a third drive shaft.

The following can thus apply in the first mode or the first speed range, it being possible, in particular, for the drive assembly to be operable as follows in the first mode or the first speed range:
The first energy machine can be connected, in particular coupled, to the travel drive and can drive it.
The second energy machine can be connected, in particular coupled, to the first power output and can drive it.
The third energy machine can be connected, in particular coupled, to the second power output and can drive it.

In the second mode or the second speed range, i.e. when a torque of the first energy machine is greater than the torque threshold value and/or a rotational speed of the first energy machine is greater than the rotational speed threshold value, the following can apply, it being possible, in particular for the drive assembly to be operable as follows in the second mode or the second speed range:
Alternatively or in addition, it is possible for the second energy machine, in particular only the second energy machine, to be connected to the travel drive. It is thus possible for the second energy machine to be coupled to the travel drive and to drive the latter.
Alternatively or in addition, it is possible for the first energy machine not to be connected to the travel drive, in particular to be decoupled from the travel drive.
Alternatively or in addition, it is possible for the first energy machine to be connected to the first and/or second power output. It is thus possible for the first energy machine, in particular, to be coupled to the first and/or second power output and to drive them (it).
Alternatively or in addition, it is possible for the third energy machine to be connected to the first and/or second power output. It is thus possible for the third energy machine, in particular, to be coupled to the first and/or second power output and to drive them (it).
Alternatively or in addition, it is possible for the second energy machine to be connected to the travel drive and the first and/or second power output. It is thus possible for the second energy machine, in particular, to be coupled to the travel drive and the first and/or second power output and to drive them (it).

Alternatively, instead of the second energy machine, the third energy machine can be connected to the fifth coupling device. In addition, the third energy machine can be connectable or connected to the second power output, in particular the second or third output shaft, by means of or by the fifth coupling device.

The drive assembly can comprise a sixth coupling device. The third energy machine can be connected to the sixth coupling device. In addition, the third energy machine can be connectable or connected to the second power output by means of or by the sixth coupling device. The sixth coupling device can be connectable or connected to the third output shaft.

The sixth coupling device can be movable between a first position, in particular a closed or connected or coupled state, and a second position, in particular an open or unconnected or decoupled state. By means of the sixth or by the sixth coupling device, it is possible for the third energy machine to be connected to the second power output, in particular the third output shaft, in the first position and not to be connected to the second power output, in particular the third output shaft, in the second position.

The sixth coupling device can be designed as a clutch or synchronizer, e.g. as a shift clutch or a multiplate clutch or a synchromesh clutch or a switchable freewheel clutch.

The drive assembly can comprise a sixth transmission stage, in particular a sixth spur gear stage or a sixth gearwheel set or a sixth gearwheel pair or a sixth planetary set. The third energy machine can be connected to the sixth coupling device by the sixth or by means of the sixth transmission stage.

The sixth coupling device can be connected to the control unit for signaling, and/or operatively coupled thereto and/or connected thereto for transmitting signals and/or carrying data. In particular, the drive assembly can comprise a sixth valve or a sixth valve arrangement, in particular a sixth control valve, or a sixth actuator for controlling and/or setting and/or adjusting the sixth coupling device. The sixth valve or the sixth valve arrangement or the sixth actuator can be connected to the sixth coupling device.

The control unit can be connected to the sixth valve or the sixth valve arrangement or the sixth actuator for signaling and/or operatively coupled thereto and/or connected thereto for transmitting signals and/or carrying data. The control unit can be configured to control and/or set and/or adjust the sixth coupling device, in particular via the or by means of the sixth valve or the sixth valve arrangement or the sixth actuator, for example to set and/or adjust it into the first or second position, for example also to move it from the first into the second position and vice versa. The drive assembly has the advantages set out above.

In a modification of the disclosure, the first power output comprises a first angular gear set and/or the second power output comprises a second angular gear set. In a modification of the disclosure, the first electric motor and the travel drive, in particular the first output shaft, and/or the second electric motor and the travel drive, in particular the first output shaft, and/or the third electric motor and the travel drive, in particular the first output shaft, are arranged coaxially with or parallel to one another. More specifically, the axes of rotation of the first electric motor and/or of the second electric motor and/or of the third electric motor and/or of the travel drive, in particular the first output shaft, can be arranged coaxially with or parallel to one another.

The disclosure furthermore relates to an axle, for example an electrically driven axle, for a work machine, comprising a drive assembly, for example a drive assembly of the one or more embodiments disclosed herein. The drive assembly can be arranged on the axle or integrated into the axle.

The disclosure furthermore relates to a work machine, comprising an axle, for example an axle of the one or more embodiments disclosed herein, or a drive assembly, for example a drive assembly of the one or more embodiments disclosed herein. The work machine can be a construction machine or a towing vehicle, for example an agricultural towing vehicle, e.g. a tractor. The work machine has the above-described advantages of the drive assembly.

The work machine comprises the drive assembly. The drive assembly is designed for driving the work machine. The work machine can comprise one, two or more axle(s). More specifically, the work machine can comprise a first and a second vehicle axle. The axle, in particular the first and/or second vehicle axle, can comprise the drive assembly. More specifically, the drive assembly can be integrated into the axle, in particular into the first and/or second vehicle axle. The work machine can be drivable with a rotational speed and/or force and/or a torque of the first and/or second and/or third energy machine. In this instance, the first vehicle axle can be a front axle, in particular a steerable front axle, and/or the second vehicle axle can be a rear axle.

The control unit can be configured for controlling, by open-loop and/or closed-loop control, in particular setting and/or adjusting, the work machine, in particular the first and second modes. The work machine can comprise an input and output unit. The control unit can be connected to the input and output unit for signaling and/or operatively coupled thereto and/or connected thereto for transmitting signals and/or carrying data, and/or can be controllable and/or settable and/or adjustable by means of the input and output unit. The input and output unit can be integrated into the control unit or vice versa. The operator of the work machine can use the input and output unit to set and/or adjust a speed of the work machine, for example.

The work machine can also comprise one or more auxiliary units, such as a pump and/or a radiator, etc. The auxiliary units can be part of the hydraulic system of the drive assembly. The work machine can comprise the first power output, in particular the PTO unit. The control unit can be configured to set and/or adjust and/or control the drive assembly and/or the axle and/or work machine by means of a driving signal and to set and/or adjust, in particular to increase or reduce, a speed of the towing vehicle by means of or based on the driving signal. The work machine can comprise the ground-engaging means. The ground-engaging means can support and/or carry the work machine on the ground. A towing-vehicle frame of the work machine can be supported on the ground-engaging means. The ground-engaging means can be wheels or tracks or chains. In particular, the ground-engaging means can be front wheels and rear wheels.

The work machine can comprise a speed sensor, e.g. a rotational speed sensor, for detecting a speed of the work machine. The control unit can be configured to set and/or adjust and/or control the drive assembly and/or the axle and/or the work machine, in particular the first and/or second and/or third energy machine and/or the PTO unit, e.g. in that the control unit is configured to set and/or adjust and/or control the valves and/or valve arrangements of these components. More specifically, the control unit can be configured to set and/or adjust and/or control a force and/or a torque and/or a rotational speed of the first and/or second and/or third energy machine.

The drive assembly or the axle or the work machine can comprise a set of power electronics. The set of power electronics and/or the energy store can be integrated into the control unit or be controllable as external unit(s) by the control unit. The set of power electronics may comprise an electronic control device and/or an inverter and/or a voltage transformer. During operation, the inverter can transform the voltage and/or current of the energy store into a voltage or energy or power that is required by the energy machine and/or the stator. This operation may be reversed for the purposes of charging the energy store. The control unit can comprise a computing unit, a computer, a processor, a memory and/or all of the software, hardware, algorithms, connections, and in particular also sensors, that are required for setting and/or adjusting the first and/or second and/or third energy machine. The energy store can be controllable by suitable control electronics in order to store electric energy and/or power and discharge it to the first and/or second and/or third energy machine. The control unit and/or the first and/or second and/or third energy machine can be electrically connected and/or electrically couplable to the set of power electronics and/or the energy store. In addition, it is possible via or by means of the set of power electronics to control and/or set and/or adjust the supply of voltage and/or current and/or energy and/or power to the drive assembly, in particular the first and/or second and/or third energy machines and/or the energy store.

The first coupling device, in particular the first valve or the first valve device or the first actuator, and/or the second coupling device, in particular the second valve or the second valve device or the second actuator, and/or the third coupling device, in particular the third valve or the third valve device or the third actuator, and/or the fourth coupling device, in particular the fourth valve or the fourth valve device or the fourth actuator, and/or the fifth coupling device, in particular the fifth valve or the fifth valve device or the fifth actuator, and/or the sixth coupling device, in particular the sixth valve or the sixth valve device or the sixth actuator, and/or the energy store and/or the set of power electronics and/or the first and/or second and/or third energy machine and/or the first power output, in particular the PTO unit, can be operable, for example controllable by open-loop and/or closed-loop control, for example drivable and/or settable and/or adjustable, by means of the control unit. The control unit can transmit and/or receive signals for controlling the operation of the drive assembly and/or the axle and/or the work machine. The signals can be expediently provided via a suitable data communication network, for example one that conforms to the ISOBUS and/or CAN standard. The control unit can be configured as an electronic module, an embedded system, a computing unit, a computer, as a module for the open-loop and/or closed-loop control of the drive assembly and/or the axle and/or the work machine. The control unit can comprise one or more processors, a memory and/or all of the software, hardware, algorithms, connections, and in particular also sensors, that are required for the open-loop and/or closed-loop control of the drive assembly and/or of the axle and/or of the work machine. Methods can be configured as a program or algorithm that can be executed on and/or by the control unit. The control unit can include any device which analyses data from various sensors, compares data and makes the necessary decisions in order to exercise open-loop and/or closed-loop control over and/or to carry out the operation of the drive assembly and/or of the axle and/or of the work machine, and in order to exercise open-loop and/or closed-loop control over and/or to carry out the tasks required for open-loop and/or closed-loop control of the operation of the drive assembly and/or of the axle and/or of the work machine. The control device can be connected for signaling and/or operatively coupled and/or connected for transmitting signals and/or carrying data to the parts of the drive assembly and/or of the axle and/or of the work machine, that is to say, in particular, the travel drive and/or the first power output, in particular the PTO unit, and/or the first coupling device, in particular the first valve or the first valve device or the first actuator, and/or the second coupling device, in particular the second valve or the second valve device or the second actuator, and/or the third coupling device, in particular the third valve or the third valve device or the third actuator, and/or the fourth coupling device, in particular the fourth valve or the fourth valve device or the fourth actuator, and/or the fifth coupling device, in particular the fifth valve or the fifth valve device or the fifth actuator, and/or the sixth coupling device, in particular the sixth valve or the sixth valve device or the sixth actuator, and/or the energy store and/or the set of power electronics and/or the first and/or second and/or third energy machine, the sensors e.g. the speed sensor and/or the rotational speed and/or torque sensor(s). Connected for signaling and/or operatively coupled and/or a connection for transmitting signals and/or carrying data can be understood as meaning, inter alia, that signals and/or data can be exchanged between the connected parts and the control unit. Signals can for example be received and transmitted, and/or processed and/or manipulated, by the control unit. The connection between the control unit and the parts or components of the drive assembly and/or of the axle and/or of the work machine can be wired, i.e. in particular by cable, and/or wireless, i.e. by radio, for example using Bluetooth or WLAN. Communication can be for example by means of Isobus, CAN bus, or the like. The control unit can be connected directly to the input and output unit which is arranged on or in the work machine and by means of which data entered by an operator can be transmitted to the control unit or received from the control unit and output. The control unit can be integrated into the input and output unit or vice versa.

The disclosure can furthermore relate to a method for operating the drive assembly, and/or the axle, and/or the work machine.

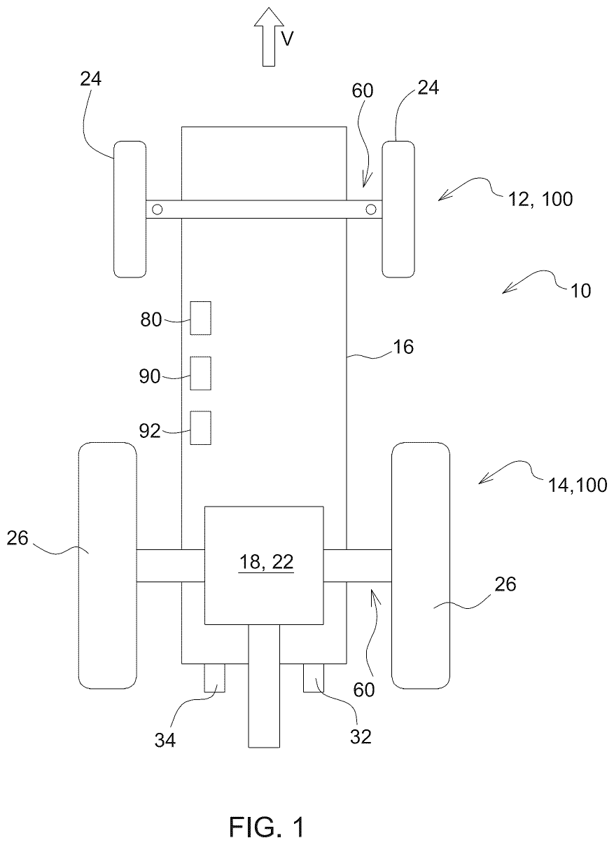

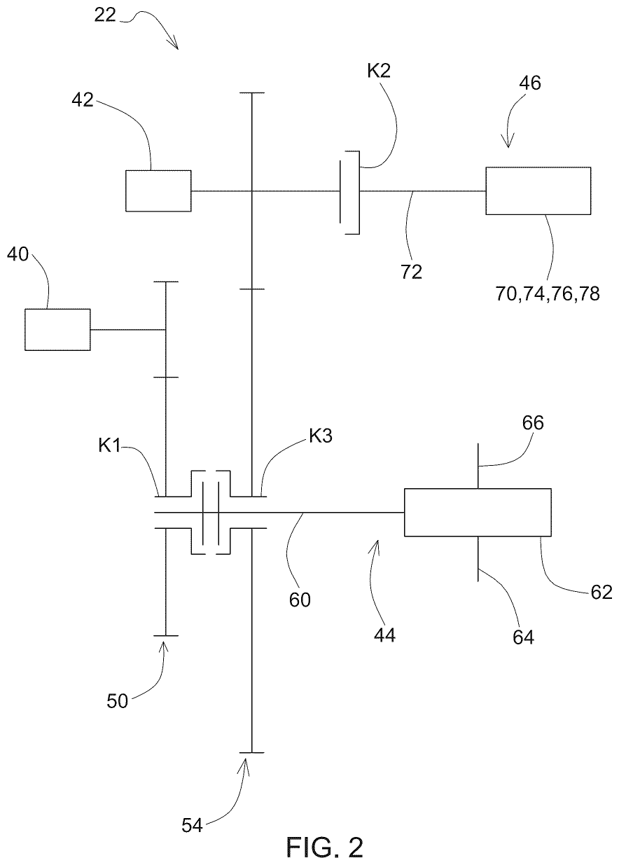

FIG. 1 shows a schematic illustration of a first example embodiment of a work machine 10, in particular an agricultural towing vehicle which is in the form of a farm tractor. The work machine 10, which is movable in a forward direction V, e.g. over a field, comprises a supporting frame 16, which is supported on the ground by two axles 100. The two axles 100 are designed as a first vehicle axle 12, in this case a steerable front axle, with ground-engaging means 24, and a second vehicle axle 14, in this case a drivable rear axle with ground-engaging means 26. The work machine 10 comprises a drive assembly 22. The work machine 10, in particular the drive assembly 22 or the axle 100, can comprise an energy store 18, in this case, for example, a battery (rechargeable battery). The energy store 18 can be electrically connected to the drive assembly 22, in particular a first and/or second and/or third energy machine 40, 42, 202 (see FIGS. 2 to 7) of the drive assembly 22. The drive assembly 22 is designed for mechanically driving a travel drive 44, in particular the axle 100, in this case the second vehicle axle 14, and/or a first power output 32. The first power output 32 can be designed as a PTO unit and can be provided for the purpose of driving an implement (not shown), which can be attached to the work machine 10 via an interface 34 (e.g. three-point interface). The axle 100, in the present case the second vehicle axle 14, can comprise the drive assembly 22. However, each axle 100, in particular the first and/or second vehicle axle 12, 14, can comprise a respective drive assembly 22. The work machine 10, in particular, however, as an alternative, also the axle 100 or the drive assembly 22, can comprise a control unit 80 and/or an input and output unit 90. The control unit 80 is connected to the first and/or second and/or third energy machine 40, 42, 202 for signaling, and/or operatively coupled thereto and/or connected thereto for transmitting signals and/or carrying data. The control unit 80 is configured to set and/or adjust the rotational speed and/or the torque of the drive assembly 22, in particular of the energy machines 40, 42, 202. The control unit 80 can be configured to set and/or adjust a specifiable rotational speed and/or a specifiable torque of the drive assembly 22, in particular of the energy machines 40, 42, 202. However, the control unit 80 can also be connected to the energy store 18 and/or to a set of power electronics 92 of the work machine 10, in particular, as an alternative, the axle 100 or the drive assembly 22 and/or sensors of the drive assembly 22, in particular, as an alternative, of the axle 100 or of the work machine 10, for signaling, and/or can be operatively coupled thereto and/or connected thereto for transmitting signals and/or carrying data. The control unit 80 can be configured to set and/or adjust the drive assembly 22 and/or the work machine 10 and/or the axle 100, for example to set and/or adjust the rotational speed and/or the torque of the first power output 32 and/or of the travel drive 44, in particular of the output shaft 60.

The energy store 18 supplies the electrically driven elements of the drive assembly 22, cf. FIGS. 2 to 7, in particular a first and/or second and/or third energy machine 40, 42, 202 with energy, in particular with currents or voltages of suitable frequency and amplitudes in order to provide desired output speeds or torques for the travel drive 44 and thus the second vehicle axle 14 and the first power output 32. The set of power electronics 92 can be electrically connected and/or electrically couplable to the first and/or second and/or third energy machine 40, 42, 202 and/or the energy store 18. The first and/or second and/or third energy machine 40, 42, 202 and the travel drive 44, in particular the first output shaft 60, can be arranged coaxially with or parallel to one another.

FIG. 2 shows a schematic illustration of the first example embodiment of the drive assembly 22 according to the disclosure. The drive assembly 22 shown in FIG. 2 corresponds substantially to the drive assembly 22 shown in FIG. 1, and therefore only details and/or points of differentiation will be discussed below. The work machine 10 illustrated in FIG. 1 can comprise the drive assembly 22 illustrated in FIG. 2.

The drive assembly 22 comprises a first and a second energy machine 40, 42 and a travel drive 44 and a first power output 46. In the first mode, when the torque of the first energy machine 40 is less than or equal to the torque threshold value and/or the rotational speed of the first energy machine 40 is less than or equal to the rotational speed threshold value, the first energy machine 40 is connected to the travel drive 44, and the second energy machine 42 is connected to the first power output 46, that is to say, in particular, is coupled thereto and drives it. In the second mode, when the torque of the first energy machine 40 is greater than the torque threshold value and/or the rotational speed of the first energy machine 40 is greater than the rotational speed threshold value, the second energy machine 42 is connected to the travel drive 44, that is to say, in particular, is coupled thereto and drives it. Furthermore, as an alternative, it is possible in the second mode for the energy machine 42 to be connected to the travel drive 44 and to the first power output 44, that is to say, in particular, to be coupled thereto and to drive them.

The drive assembly 22 comprises a first coupling device K1, wherein the first energy machine 40 is connected to the first coupling device K1. The first energy machine 40 is connectable or connected to the travel drive 44 by means of the first or by the first coupling device K1. The drive assembly 22 furthermore comprises a second coupling device K2. The second energy machine 42 is connectable or connected to the first power output 46 by means of the second or by the second coupling device K2. The drive assembly 22 furthermore comprises a third coupling device K3. The second energy machine 42 is connectable or connected to the travel drive 44 by means of the third or by the third coupling device K3.

The drive assembly 22 furthermore comprises a first and third transmission stage 50, 54. The first energy machine 40 is connected to the first coupling device K1 by the first or by means of the first transmission stage 50. The second energy machine 42 is connected to the third coupling device K3 by the third or by means of the third transmission stage 54.

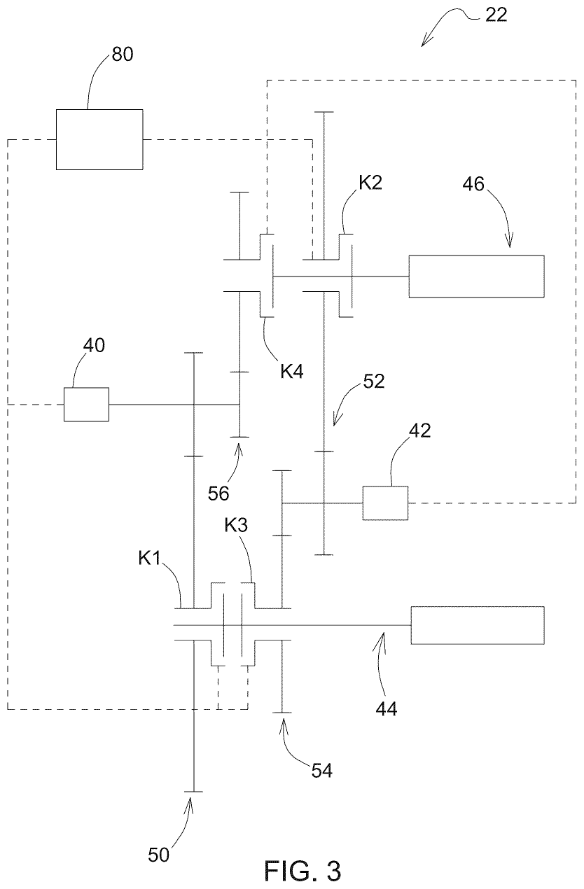

The first and second and third coupling device K1, K2, K3 are connected to the control unit 80 (see FIG. 3), in particular connected for signaling and/or operatively coupled thereto and/or connected thereto for transmitting signals and/or carrying data.

The first, second and third coupling device K1, K2, K3 can be settable and/or adjustable between the first position and the second position, in particular also can be movable from the first into the second position and vice versa (for details, see above).

The travel drive 44 is designed as a first output shaft 60 and a differential 62. However, the travel drive 44 may also comprise only the first output shaft 60 and/or be designed as a first output shaft 60. The differential 62 is connected on the drive side to the first output shaft 60. In addition, the differential 62 can be connected on the driven side to a left-hand shaft 64 and to a right-hand shaft 66 in order to drive ground-engaging means 26 on the axle 14, 100. The first output shaft 60 can be designed as a hollow shaft, which, in particular, partially or completely surrounds the left-hand and/or right-hand shaft 64, 66. The shafts 64, 66 are rigidly connected to the driven outputs of the differential 62.

The drive assembly 22 comprises the first power output 46. The first power output 46 can be designed as a PTO unit 70, and/or can comprise the latter. The PTO unit 70 can comprise a PTO gear set 74 and/or a power takeoff shaft 76 and/or the second output shaft 72. The PTO unit 70, in particular the PTO gear set 74, can be connected on the drive side to the second output shaft 72. In addition, the PTO unit 70 can be connected on the driven side to the power takeoff shaft 76. However, the first power output 46 may also comprise only the second output shaft 72 and/or be designed as a second output shaft 72. The first power output 46 can furthermore comprise a first angular gear set 76 and/or a second angular gear set 78. A second power output 200 can likewise comprise the second angular gear set 78.

FIG. 3 shows a schematic illustration of a second example embodiment of the drive assembly 22 according to the disclosure. The drive assembly 22 shown in FIG. 3 corresponds substantially to the drive assembly 22 shown in FIGS. 1 and 2, and therefore only details and/or points of differentiation will be discussed below. The work machine 10 illustrated in FIG. 1 can comprise the drive assembly 22 illustrated in FIG. 3.

The drive assembly 22 comprises a fourth coupling device K4, wherein the first energy machine 40 is connected to the fourth coupling device K4. The first energy machine 40 is connectable or connected to the first power output 46 by means of the fourth or by the fourth coupling device K4. The drive assembly 22 furthermore comprises a second and fourth transmission stage 52, 56. The first energy machine 40 is connected to the fourth coupling device K4 by the fourth or by means of the fourth transmission stage 56. The second energy machine 42 is connected to the second coupling device K2 by the second or by means of the second transmission stage 52. The fourth coupling device K4 can likewise be settable and/or adjustable between the first position and the second position, in particular also can be movable from the first into the second position and vice versa (for details, see above).

The first, second, third and fourth coupling device K1, K2, K3, K4 are connected to the control unit 80, in particular connected for signaling and/or operatively coupled thereto and/or connected thereto for transmitting signals and/or carrying data (see dashed line). More specifically, the drive assembly 22, in particular the first coupling device K1, can comprise a first valve or a first valve arrangement (not shown), in particular a first control valve, or a first actuator for controlling and/or setting and/or adjusting the first coupling device K1. The drive assembly, in particular the second coupling device K2, can likewise comprise a second valve or a second valve arrangement (not shown), in particular a second control valve, or a second actuator for controlling and/or setting and/or adjusting the second coupling device K2. The drive assembly, in particular the third coupling device K3, can likewise comprise a third valve or a third valve arrangement (not shown), in particular a third control valve, or a third actuator for controlling and/or setting and/or adjusting the third coupling device K3. The drive assembly, in particular the fourth coupling device K4, can likewise comprise a fourth valve or a fourth valve arrangement (not shown), in particular a fourth control valve, or a fourth actuator for controlling and/or setting and/or adjusting the fourth coupling device K4. The control unit can be connected to the first and/or second and/or third and/or fourth valve and/or the first and/or second and/or third and/or fourth valve arrangement and/or the first and/or second and/or third and/or fourth actuator for signaling and/or operatively coupled thereto and/or connected thereto for transmitting signals and/or carrying data. The control unit can be configured to control and/or set and/or adjust the coupling devices K1, K2, K3, K4 devices, in particular via the valves or the valve arrangements, for example to set and/or adjust them into the first or second position, in particular also to move them from the first into the second position and vice versa.

The control unit 80 is connected to the first and second energy machine 40, 42 for signaling, and/or operatively coupled thereto and/or connected thereto for transmitting signals and/or carrying data. The control unit can be configured to set and/or adjust the drive assembly 22, in particular the first and second energy machine 40, 42, in accordance with the rotational speed and/or the torque in the first or second mode, in particular to operate them in the first or second mode. The control unit 80 can be configured to set and/or adjust and/or control, that is to say, in particular, to exercise open-loop and closed-loop control over, the drive assembly 22 and thus also the work machine 10 by means of or in accordance with the rotational speed and/or torque of the first energy machine 40. The control unit 80 can be present with the same functionality and connections, in particular, also in the embodiments in FIGS. 1, 2 and 4 to 5, even if the control unit 80 is not shown.

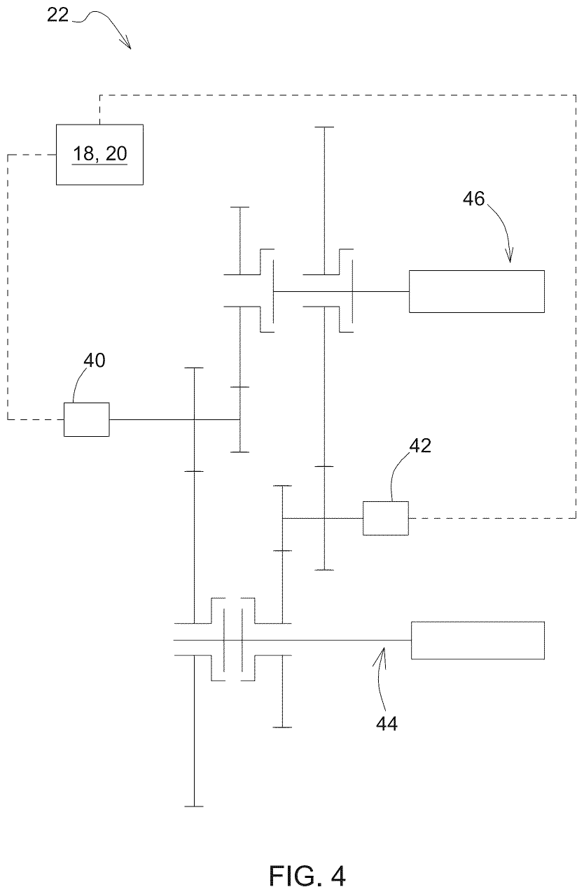

FIG. 4 shows a schematic illustration of a third example embodiment of the drive assembly 22 according to the disclosure. The drive assembly 22 shown in FIG. 4 corresponds substantially to the drive assembly 22 shown in FIGS. 1 to 3, and therefore only details and/or points of differentiation will be discussed below. The work machine 10 illustrated in FIG. 1 can comprise the drive assembly 22 illustrated in FIG. 4.

In the embodiment illustrated, the work vehicle 10 is driven by purely electric means, for which purpose an energy store 18, in this case a battery (rechargeable battery) is used. The energy store 18 is connected electrically to a drive assembly 22. The energy supply for the drive assembly 22 is provided electrically by means of the energy store 18. The control unit 80 can be connected to the energy store. The energy store 18 can likewise comprise a controller 20. The controller 20 can be configured to set and/or adjust the energy store. The controller 20 can be configured to supply the electrically driven elements of the drive assembly 22 with currents or voltages of suitable frequency and amplitude.

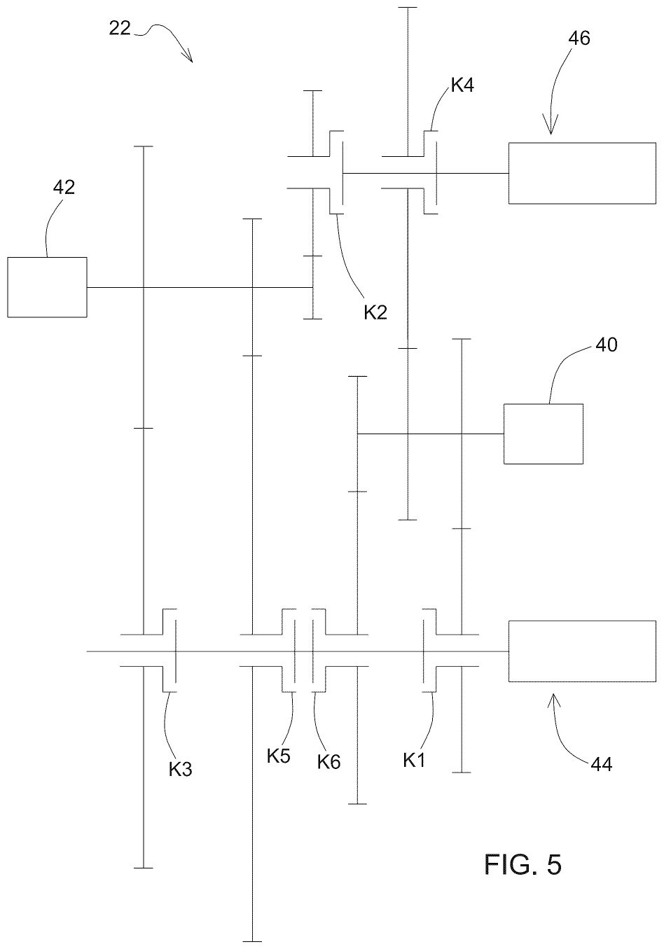

FIG. 5 shows a schematic illustration of a fourth example embodiment of the drive assembly 22 according to the disclosure. The drive assembly 22 shown in FIG. 5 corresponds substantially to the drive assembly 22 shown in FIGS. 1 to 4, and therefore only details and/or points of differentiation will be discussed below. The work machine 10 illustrated in FIG. 1 can comprise the drive assembly 22 illustrated in FIG. 5.

In order to implement a drive assembly 22 with more than 2 gears for the travel drive, it can comprise more coupling devices and transmission stages, which are connectable or are connected to the travel drive 44. However, it is important that the uneven and even gears are assigned to separate energy machines in order to allow seamless shifting between the gears. FIG. 5 shows a drive assembly 22 with 3 gears with a first and a third speed, which are implemented by means of the first energy machine 40, and a second speed, which is implemented by means of the second energy machine 42. The travel drive 44 of the first power output 46 can be shifted seamlessly.

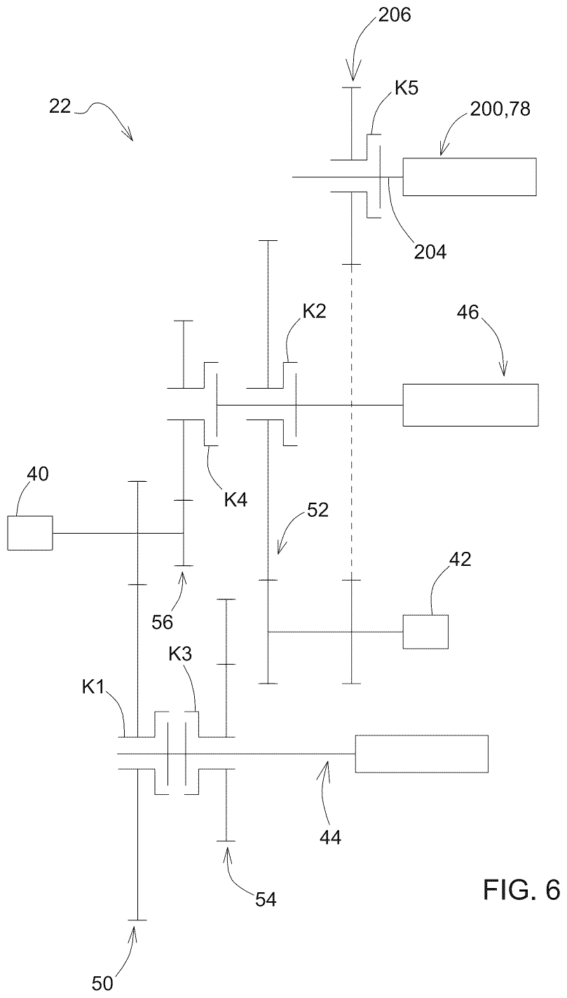

FIG. 6 shows a schematic illustration of a fifth example embodiment of the drive assembly 22 according to the disclosure. The drive assembly 22 shown in FIG. 6 corresponds substantially to the drive assembly 22 shown in FIGS. 1 to 5, and therefore only details and/or points of differentiation will be discussed below. The work machine 10 illustrated in FIG. 1 can comprise the drive assembly 22 illustrated in FIG. 6.

The drive assembly 22 comprises a second power output 200. The second power output 200 can comprise a third output shaft 204 and/or be designed as a third output shaft 204. The second power output 200 can be designed as a further PTO unit or can comprise the latter. The further PTO unit can be of identical design to the PTO unit. Alternatively or in addition, the second power output 200 can be connected to the hydraulics, e.g. a pump and/or compressor unit. The second power output 200 can comprise the second angular gear set 78.

The first energy machine 40 is connected to the travel drive 44, and the second energy machine 42 is connected to the first and/or second power output 46, 200, when a rotational speed n of the first energy machine 40 is less than or equal to the rotational speed threshold value n_{schwell}, for example when a rotational speed n of the first energy machine 40 is less than the rotational speed threshold value n_{schwell}, and the second energy machine 42 is connected to the travel drive 44 when a rotational speed n of the first energy machine 40 is greater than the rotational speed threshold value n_{schwell}.

By means of the fifth or by the fifth coupling device K5, it is possible for the second energy machine 42 to be connected to the second power output 200, in particular the second or third output shaft 72, 204 in the first position, and not to be connected to the second or third power output 46, 200, in particular the second or third output shaft 72, 204, i.e. to be decoupled, in the second position. The drive assembly 22 can comprise a fifth transmission stage 206. The second energy machine 42 can be connected to the fifth coupling device K5 by the fifth or by means of the fifth transmission stage 206.

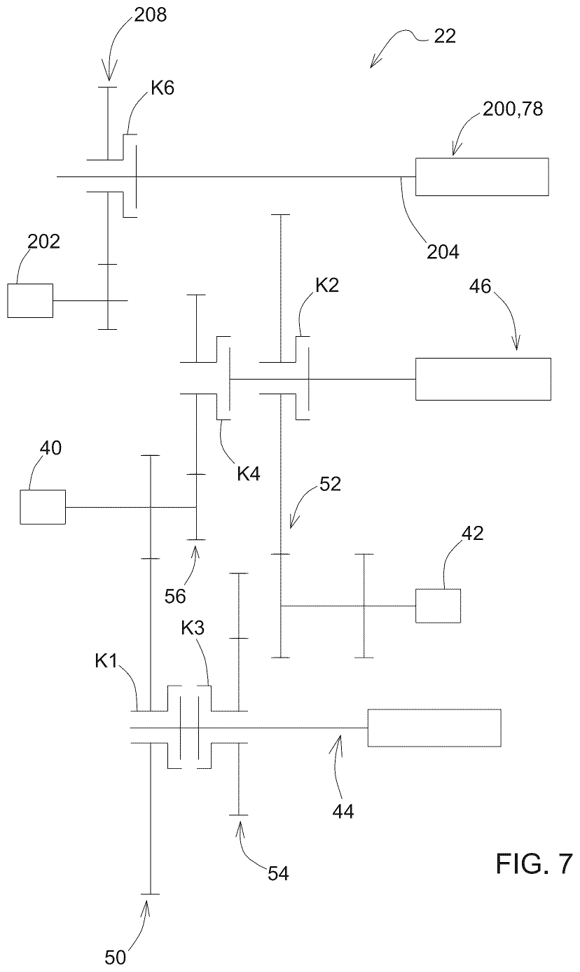

FIG. 7 shows a schematic illustration of a sixth example embodiment of the drive assembly 22 according to the disclosure. The drive assembly 22 shown in FIG. 7 corresponds substantially to the drive assembly 22 shown in FIGS. 1 to 6, and therefore only details and/or points of differentiation will be discussed below. The work machine 10 illustrated in FIG. 1 can comprise the drive assembly 22 illustrated in FIG. 7.

The drive assembly 22 comprises a third energy machine 202. The third energy machine 202 is connected to the second power output 200. Alternatively or in addition, the third energy machine 202 can be connected to the second power output 200 when a rotational speed n of the first energy machine 40 is less than or equal to the rotational speed threshold value N_{schwell}, for example when a rotational speed n of the first energy machine 40 is less than the rotational speed threshold value n_{schwell}.

By means of the sixth or by the sixth coupling device K6, the third energy machine 202 can be connected to the second power output 200, in particular the second or third output shaft 72, 204, in the first position and not be connected to the second or third power output 46, 200, in particular the second or third output shaft 72, 204, i.e. to be decoupled, in the second position.

The drive assembly 22 can comprise the sixth transmission stage 208. The third energy machine 202 can be connected to the sixth coupling device K6 by the sixth or by means of the sixth transmission stage 206. The first and/or second and/or third electric motor 40, 42, 202 and/or the travel drive 44 can be arranged coaxially with or parallel to one another.

All the embodiments of the drive assembly 22 which are shown are distinguished by a compact construction and/or their shiftability, in particular synchronized and/or seamless shiftability.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drive assembly for a work machine, comprising:
a first energy machine;
a second energy machine;
a travel drive; and
a first power output;
wherein the first energy machine is connected to the travel drive and the second energy machine is connected to the first power output when a rotational speed of the first energy machine is less than or equal to a rotational speed threshold value, and the second energy machine is connected to the travel drive when a rotational speed of the first energy machine is greater than the rotational speed threshold value.

2. The drive assembly of claim 1, wherein the second energy machine is connected to the travel drive and the first power output when the rotational speed of the first energy machine is greater than the rotational speed threshold value.

3. The drive assembly of claim 1, wherein the drive assembly comprises a first coupling device, wherein the first energy machine is connected to the first coupling device and is connectable to the travel drive via the first coupling device, and the drive assembly comprises a second coupling device, wherein the second energy machine is connected to the second coupling device and is connectable to the first power output via the second coupling device.

4. The drive assembly of claim 3, wherein the drive assembly comprises a third coupling device, and the second energy machine is connected to the third coupling device and is connectable to the travel drive via the third coupling device.

5. The drive assembly of claim 4, wherein the drive assembly comprises a fourth coupling device, and the first energy machine is connected to the fourth coupling device, and the first energy machine is connectable to the first power output via the fourth coupling device.

6. The drive assembly of claim 1, wherein the drive assembly comprises a second power output.

7. The drive assembly of claim 6, wherein the first energy machine is connected to the travel drive, and the second energy machine is connected to at least one of the first or second power output, when a rotational speed of the first energy machine is less than or equal to the rotational speed threshold value, and the second energy machine is connected to the travel drive when a rotational speed of the first energy machine is greater than the rotational speed threshold value.

8. The drive assembly of claim 6, wherein the drive assembly comprises a third energy machine connected to the second power output.

9. The drive assembly of claim 6, wherein the first power output comprises a first angular gear set, and the second power output comprises a second angular gear set.

10. The drive assembly of claim 8, wherein the first, second, and third energy machines and the travel drive are arranged coaxially with or parallel to one another.

11. An axle for a work machine including a drive assembly, comprising:
a first energy machine;
a second energy machine;
a travel drive; and
a first power output;
wherein the first energy machine is connected to the travel drive and the second energy machine is connected to the first power output when a rotational speed of the first energy machine is less than or equal to a rotational speed threshold value, and the second energy machine is connected to the travel drive when a rotational speed of the first energy machine is greater than the rotational speed threshold value.

12. The axle of claim 11, wherein the second energy machine is connected to the travel drive and the first power output when the rotational speed of the first energy machine is greater than the rotational speed threshold value.

13. The axle of claim 11, wherein the drive assembly comprises a first coupling device, wherein the first energy machine is connected to the first coupling device and is connectable to the travel drive via the first coupling device, and the drive assembly comprises a second coupling device, wherein the second energy machine is connected to the second coupling device and is connectable to the first power output via the second coupling device.

14. The axle of claim 13, wherein the drive assembly comprises a third coupling device, and the second energy machine is connected to the third coupling device and is connectable to the travel drive via the third coupling device.

15. The axle of claim 14, wherein the drive assembly comprises a fourth coupling device, and the first energy machine is connected to the fourth coupling device, and the first energy machine is connectable to the first power output via the fourth coupling device.

16. The axle of claim 11, wherein the drive assembly comprises a second power output.

17. The axle of claim 16, wherein the first energy machine is connected to the travel drive, and the second energy machine is connected to at least one of the first or second power output, when a rotational speed of the first energy machine is less than or equal to the rotational speed threshold value, and the second energy machine is connected to the travel drive when a rotational speed of the first energy machine is greater than the rotational speed threshold value.

18. The axle of claim 16, wherein the drive assembly comprises a third energy machine connected to the second power output.

19. The axle of claim 16, wherein the first power output comprises a first angular gear set, and the second power output comprises a second angular gear set.

20. The axle of claim 18, wherein the first, second, and third energy machines and the travel drive are arranged coaxially with or parallel to one another.
